(19) United States
(12) Patent Application Publication
(10) Pub. No.: US 2012/0013621 A1
(43) Pub. Date: Jan. 19, 2012

(54) System and Method for Facilitating the Creation of Animated Presentations

(75) Inventor: Juan Carlos Ospina Gonzalez, Buenos Aires (AR)

(73) Assignee: Miniclip SA

(21) Appl. No.: 12/837,324

(22) Filed: Jul. 15, 2010

(51) Int. Cl. G06T 15/70

(52) U.S. Cl. 345/473

(57) ABSTRACT

The system and method of creating animated presentations of the present invention focuses largely on the ability for web users with little training to easily create and share animated presentations with other users on the web in addition to allowing experienced artists to share and gain recognition for their works. The system according to the present invention further makes use of manipulable puppets that permit adjustment at several joints in order to facilitate the illusion of movement. The user can very simply adjust the puppet in each frame to their liking and then the system combines the frames into an animated presentation. The user is further able to use other tools available in the animation creator to, for example, adjust the background of the animation, edit the facial expression of the puppet, add text, and/or other shapes to the animation in order to create a unique animated presentation.

### FIELD OF THE INVENTION

This invention relates generally to the use of computers to create animations, drawings and presentations online in a browser and, more particularly, to an improved system and method for creating and sharing animations, drawings and presentations.

### BACKGROUND OF THE INVENTION

Recent increases in computer processing power and data transmission capacity have enabled increasingly advanced entertainment and educational computer-based offerings to be delivered via the internet to the average consumer, gamer or student. One such offering that has experienced increased demand is that of computer-based entertainment, including games, videos and artistic endeavors. A feature shared by all three of these categories is animation, which, as used herein, is meant to refer to the process of displaying a sequence of slightly differing images, also called frames, in rapid succession to create the illusion of movement. While this is not a new concept, its implementation for use via the Internet in a browser-based system primarily for non-professional or amateur users has not heretofore been accomplished. Interestingly, the system of the present invention may also be useful to professionals users in order to gain exposure within an on-line community.

Even though several different approaches to making animated presentations have been introduced over the years, many of which are very powerful, they traditionally have been extremely difficult for amateurs to use. This is because, even for a simple animated presentation, these prior art applications require a technical or mathematical aptitude and an understanding of an extensive library of tools, terminology and modeling paradigms that are unfamiliar to non-technical users and do not supply an easy, standardized or centralized way to share and/or publish the resulting works to gain exposure and feedback for the creator.

It is an object of the present invention to provide a system and method of creating animations and presentations that is simple enough to use that amateur users, such as children, can immediately use it and then share their resulting work without excessive experimentation or training

Another barrier to the amateur use of prior art animation applications has been the fact that they do not permit creative experimentation with different editing tools on pre-drawn elements or “puppets” as they are referred to herein. For many users, a requirement that they draw each character they wish to use in an animation means they must spend a comparatively large amount of energy and time in creating non-essential elements of the presentation or story they want to convey. As a result, it is also an object of the present invention to provide puppets that can be incorporated into an animation or presentation and can be easily manipulated within a scene.

An additional drawback inherent in currently available animation tools is that they have steep learning curves that do not enable the casual or non-technical user to immediately and easily realize the advantages of the computing power available to them. In addition, existing animation tools do not lend themselves to quick, non-precise modifications of the finished product and do not provide comprehensive and easy sharing facilities—thereby making them poor tools for the casual user. Moreover, to the extent that the casual user does end up creating an animation and wishes to share it with friends, colleagues, classmates or others, the recipient must often obtain additional software in order to view it and would need to use other unrelated additional software or services to attempt to share it which would happen in a non centralized and non consistent manner.

In accordance with at least one presently preferred embodiment of the invention, there is broadly contemplated herein a system and method for facilitating the creation of simple animated presentations. In further accordance with the present invention, a user creates an animation by drawing individual images or pictures, called frames, placing them on what amounts to a film strip, and then presenting them one after the other in rapid succession to create an animated presentation. In its end result, the present invention is designed to be extremely easy to use with very little training

Another object of the present invention is to provide users with the ability to easily share their animated presentations with other users. This ability to share animated presentations is further provided with the ability of users to receive data and feedback on their works with statistics for the number of views and the number of users who have marked the work as a favorite animated presentation which have been published to an online community.

A still further object of the preferred embodiment of the present invention is to provide manipulable pre-drawn elements, called puppets for use in animated presentations. These manipulable puppets have one or a plurality of axis points (joints) that allow a relatively untrained user to rotate the limbs of the puppet about one or plurality of the axis points in order to facilitate the illusion of movement and expression from one frame to the next. When working with a puppet that comprises a pre-drawn person, the axis point might be a knee joint or an elbow joint, for example.

In view of the foregoing, a need has been recognized in connection with improving upon the shortcomings and disadvantages of current systems and methods for the creation and sharing of animated presentations. For a better understanding of the present invention, together with other and further features and advantages thereof, reference is made to the following description, taken in conjunction with the accompanying drawings, and the scope of the invention that will be pointed out in the appended claims.

### SUMMARY OF THE INVENTION

The present invention comprises methods and systems for enabling the creation of animations, drawings and presentations online in a browser and, more particularly, to an improved system and method for creating and sharing animations, drawings and presentations.

One aspect of the present invention provides for a method of creating an animated presentation using pre-drawn objects, the method comprising the steps of starting with a blank canvas and inserting at least one pre-drawn object into at least two frames to be included in the animated presentation. Then the user can select at least one pre-drawn object and use editing tools to modify it and then the frames can be played back in a predetermined sequence. Preferably, the method also includes the use of a timeline that graphically displays the frames in the order that has been predetermined for ease of reference and modification. In addition, the user can also include the step of editing just a foreground layer or a background layer in order to facilitate the creation of the animated presentation. In yet another aspect, the present invention can include the step of publishing the presentation to an online community for others to see. Further, the user can view a ghost frame in order to facilitate a smooth transition from one frame to the next. In a preferred embodiment, the pre-drawn object can be a manipulable puppet comprising at least one joint that allows the user to manipulate at least one limb to facilitate the illusion of movement as part of the presentation.

In yet a further aspect of the present invention, a system for creating an animated presentation is provided comprising a blank canvas arrangement being configured to allow a user to edit a frame, an editing tools arrangement, an object toolbar arrangement preferably including at least one pre-drawn object that can comprise a manipulable puppet that further comprises at least one joint allowing the user to manipulate at least one limb as part of the animated presentation. In a further aspect of the invention, the system of the present invention comprises a publishing arrangement configured to allow the user to save, upload and publish the animated presentation to an online community. In still another aspect of the invention, the system comprises a timeline arrangement configured to allow the user to move between frames of the animated presentation in order to edit each frame individually with the option of editing either a foreground layer or a background layer. Still another aspect of the invention comprises the addition of a ghost frame to enable the user to see the desired motion of an object from one frame to the next.

Furthermore, an additional aspect of the invention provides a computer readable medium storing instructions for an animated presentation creation application, wherein the instructions are arranged to cause one or more processors to perform the steps of the invention.

### BRIEF DESCRIPTION OF THE DRAWINGS

FIG. 1 broadly illustrates the system for creating animated presentations according to the present invention.

FIGS. 2a to 2c illustrate the timeline element of the system for creating animated presentations according to the present invention.

FIG. 3 generally illustrates the editing tools according to a preferred embodiment of the present invention.

FIG. 4 illustrates the object toolbar of the presently preferred embodiment according to the present invention.

FIGS. 5a and 5b broadly illustrate the use of the manipulable puppet selector according to a presently preferred embodiment according to the present invention.

FIGS. 6a and 6b illustrate the manipulation of a puppet in accordance with the present invention.

### DESCRIPTION OF THE PREFERRED EMBODIMENTS

The present invention provides an improved animated presentation creation engine. In the present invention, a user can create an animation by starting with a blank canvas and drawing a series of individual images or pictures, called frames, or selecting from a series of pre-drawn manipulable elements, and then presenting them, one after the other, to create an animated presentation. In a presently preferred embodiment, the disclosed invention is designed to allow a user, completely untrained in animation techniques, to create a sequence of images or frames, and then rapidly display these frames, back to back, creating an animated presentation. This system therefore allows amateur users, including children, to create animated presentations with little or no training beforehand.

The methods described in this detailed description are typically coded in software and stored on a computer-readable storage medium, which may be any device or medium that can store code and/or data for use by a computer system. This includes, but is not limited to, magnetic and optical storage devices such as disk drives, magnetic tape, compact discs and DVD's. In a preferred embodiment, the computer-readable storage medium housing the software embodying the methods disclosed herein is located on a computing device that is distant from the user. In such a case, the computer-readable storage medium is accessed by a user through the use of their personal computer connected to the internet via a browser as is commonly known.

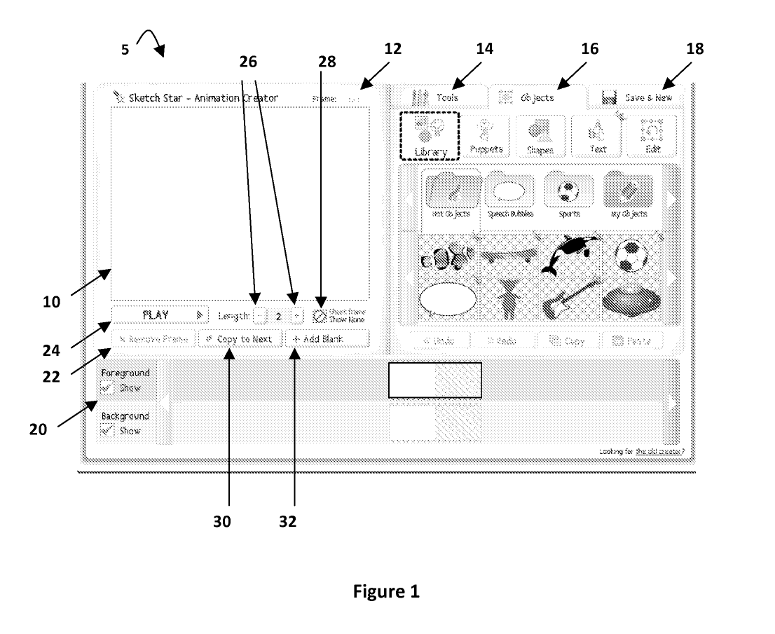

FIG. 1 broadly illustrates a blank canvas arrangement 5 of the animation creator according to a preferred embodiment of the present invention. FIG. 1 also shows a current frame 10, a current frame indicator 12, an editing tools tab 14, an objects toolbar tab 16, a save/new tab 18, and a timeline 20. While all of these elements will be discussed in greater detail later, a general description will be provided here. The current frame 10 is the portion of the animation creator where the user creates each new frame in what will ultimately be an animated presentation. The current frame indicator 12 allows the user to see which frame, in a series of frames, he is currently editing. The editing tools tab 14 provides the user with access to a plurality of drawing and editing tools for adding variety to each frame and thus, to the animated presentation. Some typical drawing and editing tools include, as will be discussed in greater detail herein, a color palette, a spray can applicator, and paint brush tools. The objects toolbar tab 16 provides the user with access to a plurality of pre-drawn elements. The objects toolbar tab 16 also provides the ability to add text bubbles to a particular animation, as well as a plurality of other editing facilities. The save/new tab 18, provides the user with the ability to publish or save their current animated presentation or start a new animated presentation.

Lastly, the timeline 20, is the feature of the animation creator that provides the user with a visual cue to easily switch between frames and also view and modify foreground and background layers of an individual frame to create a multi-layered animation.

Also shown in FIG. 1, are a remove frame button 22, a play button 24, a frame length button 26, a ghost frame button 28, a copy to next button 30, and an add blank button 32. The remove frame button 22, allows a user to completely remove a single frame from the animated presentation. The play button 24, allows the user to preview the animation by displaying the frames back to back in order. After the play button has been selected and while the animation is being displayed, it becomes a stop button that the user can then click to end the preview. The frame length buttons 26, allow the user to determine the length of time that a particular frame is played. The user can intuitively increase or decrease the length of time that a frame is played by clicking on the plus and minus frame length buttons. The ghost frame button 28, allows the user to view muted versions of the frames before and after the current frame that is being created or modified. This ghost format helps the amateur animator create a smoother final product. By default, no ghost frame is shown; however, when the ghost frame button 28 is clicked once by the user, a ghost image of the previous frame will appear in the current frame, if there is a previous frame. Clicking the ghost frame button 28 a second time will cause a ghost image of the next frame in the sequence to appear over the current frame, if there is a next frame. Clicking the ghost frame button 28 a final time will hide all ghost frames. The copy to next button 30, provides the user with the convenient ability to create a new frame by duplicating the current frame that the user is working on. This feature is very convenient in an animation sense, because it allows the user to quickly replicate and modify, for example, the movement of a car by inching the car forward slightly in the new frame. Lastly, the add blank button 32 adds an extra blank frame to the current animated presentation.

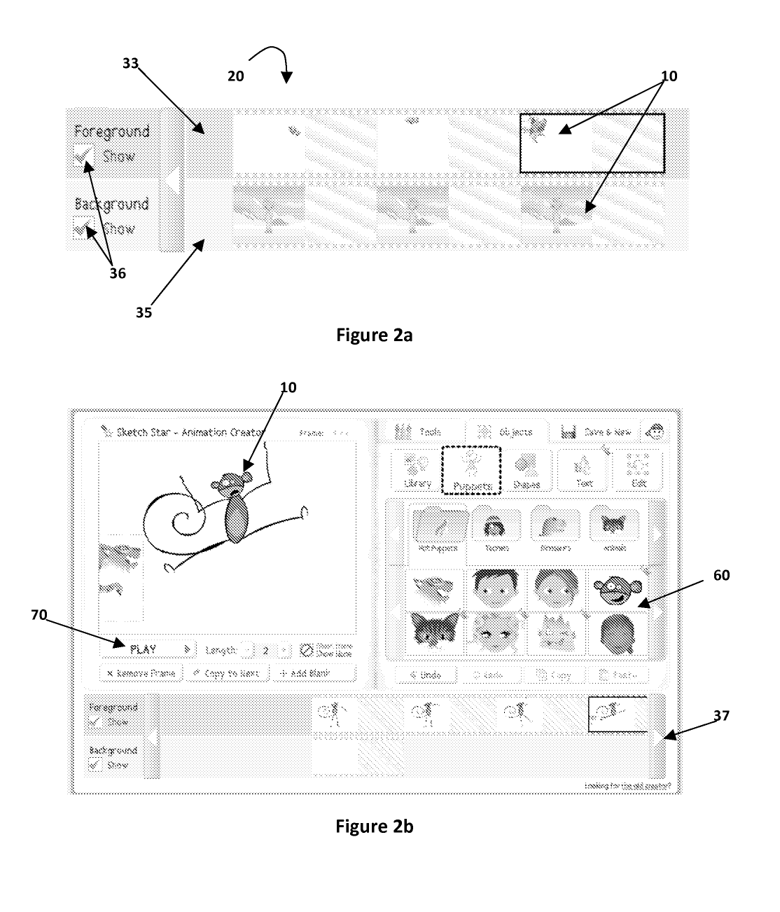

FIGS. 2a and 2b more specifically illustrate the timeline 20 of the present invention, which facilitates navigation from frame to frame in order to make it easier to move back and forth between frames during the editing process. Timeline 20 also allows the user to rearrange the frames by dragging and dropping the current frame 10 to a different location along the timeline 20. As shown in FIG. 2a, the timeline 20 provides the user with the ability to edit foreground and background layers in order to create a multi-layer animated presentation. Thus, a user may edit the foreground of an animation without fear of changing the background and likewise edit the background without fear of changing the foreground. To edit a current frame 10, the user selects a layer by clicking on the corresponding strip, such as the foreground strip 33 or the background strip 35 whereupon it is highlighted to the user. The timeline 20 also provides the user with the ability to hide or show a layer. Hiding or showing a layer is accomplished by clicking on the checkmark box 36 in either the foreground strip 33 or the background strip 35. As shown in FIG. 2b, the timeline 20 also provides the user with the ability to navigate between frames by selecting the arrows 37 at either end of the timeline 20. The arrows 37 allow the user to navigate forward or backward, and thereafter select the frame in the animated presentation that they desire to edit.

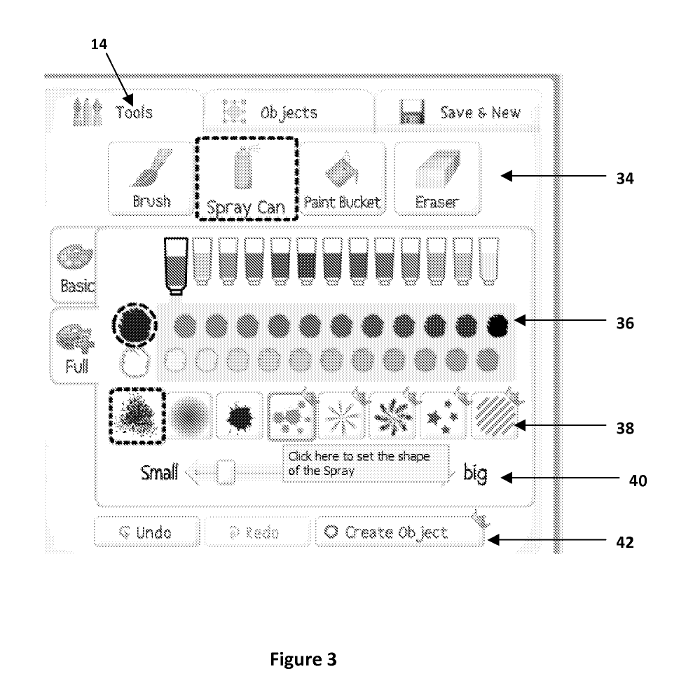

FIG. 3 broadly illustrates the editing tools available to the user when the editing tools tab 14 is selected. The editing tools selector 34 preferably includes paintbrush, spray-can, paint-can, and eraser elements. The paint brush element acts just as an actual paint brush would, allowing the user to brush strokes onto the current frame using different-sized brush tips and sizes. The spray-can element allows the user to hold down the left mouse button to spray, the longer the user's mouse button is depressed the more paint will be sprayed into the current frame. The paint-can tool allows the user to paint larger areas of the frame the same color. Lastly, the eraser element allows the user to remove unwanted painting mistakes from the current frame, or to use the different eraser tip shapes to create interesting “holes” in the foreground layer.

As further illustrated in FIG. 3, the user can select a color and shade from the color palette 36 to add even more variety to the animated presentation. After selecting an editing tool and color, the user can preferably choose from the selection of editing tool tips and sizes. The editing tool tip selector 38, features many different shapes, from circles to stars. The editing tool size selector 40, allows the user to choose the size of the editing tool tip.

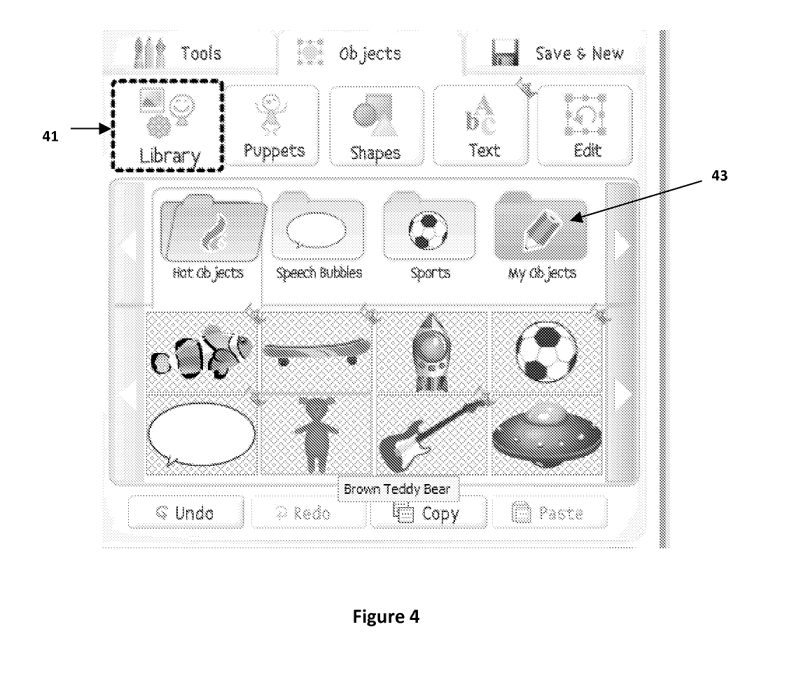

FIG. 4 broadly illustrates an object toolbar 41 of the presently preferred embodiment according to the present invention. As shown in FIG. 4, the user has the ability to choose from a variety of pre-drawn objects, puppets and shapes to add to the animated presentation, or the user can also create a unique object and save it for later use. As will be described in further detail, many of the pre-drawn objects can be further manipulated and edited by the user after being added to the current frame.

The user can also create and save custom objects for use in the current animated presentation or the next animated presentation created at a later date. To create a new custom object the user simply selects the create object toggle 42, featured in FIG. 3, which will convert the function into a stop recording toggle similar to the play/stop button previously mentioned. After selecting the create object toggle 42, the user can then create or modify any object by using any of the editing tools previously described. After the user is finished creating or modifying the custom object, the stop recording toggle is selected, and the new custom object is preferably automatically saved into the my objects folder 43 of the object toolbar 41, as shown in FIG. 4. Thereafter the custom object is available to the user in the my objects folder 43 of the object toolbar 41, where it can be permanently saved for future use.

The object toolbar 41 as shown in FIG. 4, also preferably allows a user to add text to an animated presentation. To add text, the user first clicks on the Text button on the object toolbar 41, then picks a color, font, and size for the text. Then the user can click on the current frame and a box will appear for the user to type into. The user can then edit the text as he goes along by highlighting it with the cursor, and then changing the color, size, or font. To move the text around, the user can hover the cursor just outside the text box and drag the text box anywhere around the frame.

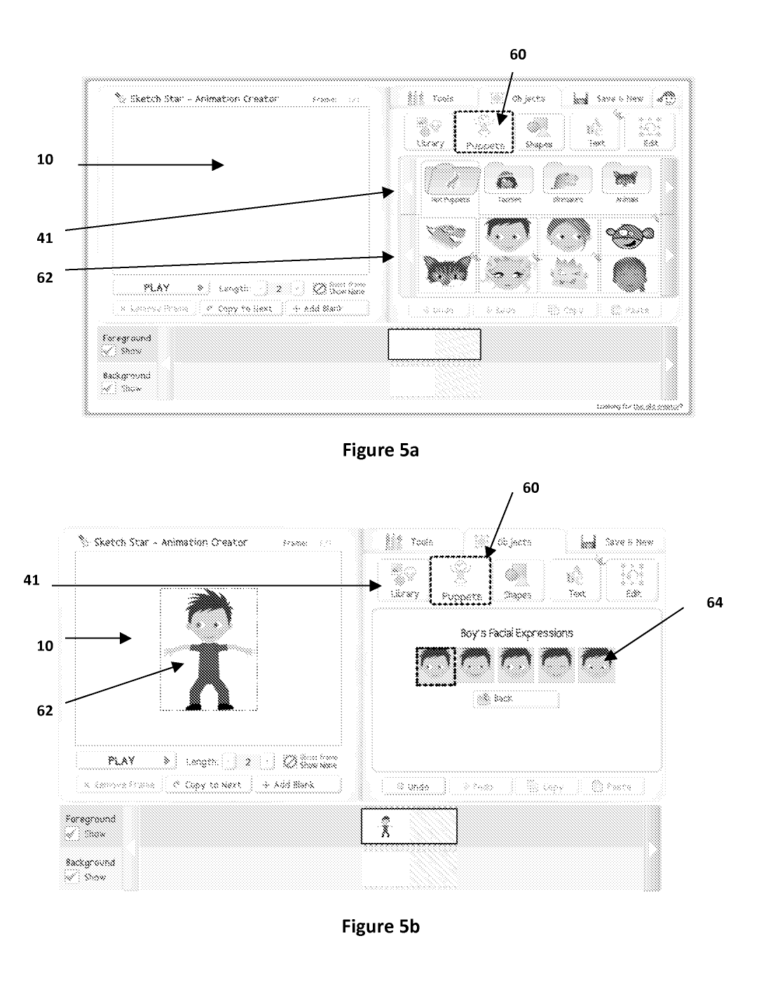

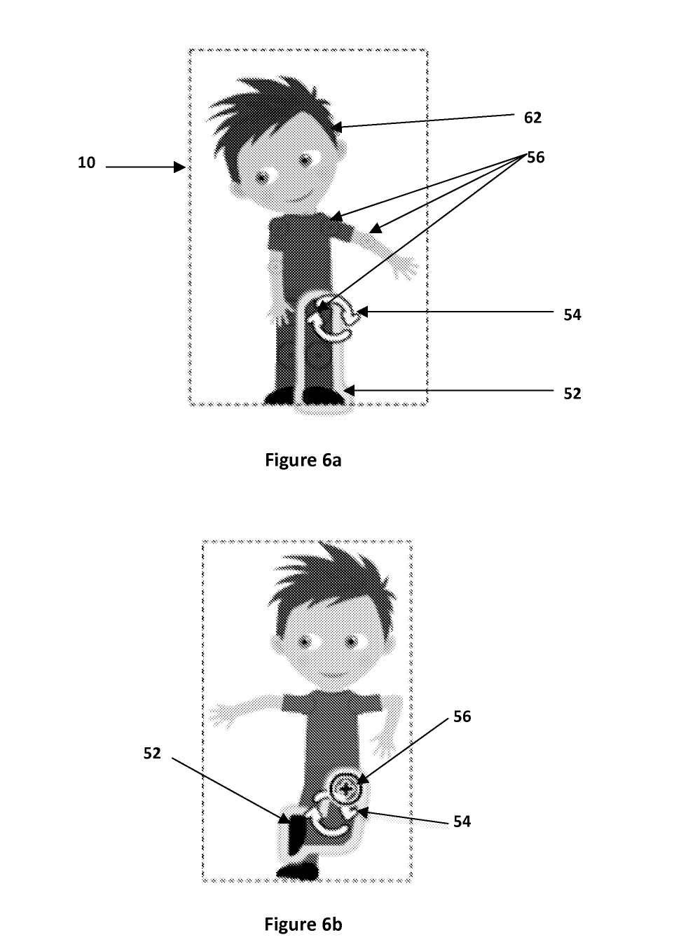

FIGS. 5a and 5b illustrate a puppet selector 60 located on the object toolbar 41 according to a presently preferred embodiment of the present invention. The puppet selector 60 provides access to a plurality of pre-drawn puppets 62, such as avatars, animals, monsters and mechanical objects, for example. Once a pre-drawn puppet 62 is selected and placed in the current frame 10, the user can change the position of limbs or other normally moveable aspects of a particular puppet as is more fully discussed with respect to FIGS. 6a and 6b. Additionally, if desired, the user can move the pre-drawn puppet 62 from side to side, also referred to as translational movement, in order to complement the rotational movement possible. This process can be repeated frame after frame, for example, to make the puppet dance around in an animated presentation.

With particular reference to FIG. 5b, each pre-drawn puppet 62 can have a plurality of facial expression options 64. The user can click on the face of a pre-drawn puppet 62 in the frame 10 to be shown the facial expression options 64 available for selection. The facial expression options 64 include, for example, the mouth in various positions of smiling or frowning, as well as the eyes in various positions of open to closed.

FIGS. 6a and 6b illustrate a specific pre-drawn puppet 62 found in the puppet selector 60 according to a specific embodiment of the present invention. As shown in FIG. 6a, the pre-drawn puppet 62 includes a plurality of rotation points 56 at the neck joint, shoulders, elbows, hips, and knees. When a manipulable element 52 that is rotatable about a rotation point 56 is selected by the user, usually with the click of a mouse, it is preferably highlighted or outlined in a different color in the current frame 10 and rotation arrows 54 are displayed as a visual cue to confirm that the manipulable element 52 that was selected can be rotated. In FIG. 6b, the movement of a manipulable element 52 is demonstrated in comparison to FIG. 6a, said movement having been accomplished by the user by “dragging” the leg about the rotation point 56 with their mouse to the desired location. Referring now to FIG. 6b, the head, arms and legs of the puppet 62 have all been rotated about their respective rotation points, such as the rotation point 56 that has been selected at the hip. In this alternative embodiment, a plus sign in a circle signifies the rotation point 56 around which rotation can occur.

Referring now to FIGS. 2b, 5b and 6a and 6b, it can be seen that in order to create an animated presentation in which the puppet appears to move, a user need only choose a puppet 62 from the puppet selector 60 and rotate manipulable elements 52 in successive frames to suggest motion and tell a story or convey a desired message. Then, when the user chooses to display the frames 10 they have created back to back to generate the animated presentation, the “play” button 70 is selected and the frames are displayed in rapid succession to give the illusion of movement or animation.

It is to be understood that the present invention, in accordance with at least one presently preferred embodiment, includes an animated presentation system which may be implemented on at least one general-purpose computer running suitable software programs. This system may also be implemented on at least one Integrated Circuit or part of at least one Integrated Circuit. Thus, it is to be understood that the invention may be implemented in hardware, software, or a combination of both.

Furthermore, the arrangements for realizing the above-described functions in accordance with the present invention can be formed as software or software modules written using a computer-readable programming language. They are not necessarily formed as functional blocks.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention. Accordingly, the drawings and description are to be regarded as illustrative in nature, and not as restrictive.

What is claimed is:

1. A method of creating an animated presentation using pre-drawn objects, comprising the steps of:
receiving a first input representing a pre-drawn object to be placed in a first frame of the animated presentation;
receiving a second input indicating a rotational operation to be performed on a portion of the pre-drawn object, and in response thereto, rotating a portion of the pre-drawn object around an indicated axis of rotation;
receiving a third input indicating the replication of the first frame into a second frame;
receiving additional inputs for additional frames; and
serially displaying the first frame, the second frame and any additional frames to create the animated presentation.

2. A method of creating an animated presentation, comprising the steps of:
starting from a blank canvas arrangement comprising a plurality of frames;
inserting at least one object into at least two frames;
editing at least one object in at least one frame; and
displaying the plurality of frames in a predetermined order.

3. The method according to claim 2, further comprising the step of using a timeline to allow the user to move between frames of the animated presentation in order to edit each frame individually.

4. The method according to claim 3, wherein using the timeline further comprises alternating between a foreground layer and a background layer of the frame to create a multi-layered animated presentation.

5. The method according to claim 4, wherein using the timeline further comprises hiding the background layer or the foreground layer in order to edit one layer without the other layer being visible.

6. The method according to claim 2, further comprising the step of publishing the animated presentation to an online community where other users can view the animated presentation.

7. The method according to claim 2, wherein editing the at least one frame comprises: selecting a color from a color palette; and selecting an editing tool, wherein the editing tool comprises: an eraser tool, wherein the eraser tool is used to fix mistakes made while editing the frame; a paint brush tool, wherein the paint brush tool is used to paint strokes on the frame; a spray-can tool, wherein the spray-can tool is used for spray painting the frame; and a paint-can tool, wherein the paint-can tool is used to fill a large area of the frame with paint.

8. The method according to claim 7, wherein editing the at least one frame further comprises: selecting an editing tool tip; and selecting an editing tool size.

9. The method according to claim 2, further comprising the step of using a ghost frame to allow the user to smooth a transition between a current frame and a previous frame or a next frame.

10. The method according to claim 9, wherein using the ghost frame further comprises superimposing the previous frame or the next frame on the current frame in ghost form.

11. The method according to claim 2, wherein including at least one object further comprises selecting at least one pre-drawn object that the user can include in the animated presentation.

12. The method according to claim 11, wherein the at least one pre-drawn object is a manipulable puppet comprising at least one joint that allows the user to manipulate at least one limb as part of the animated presentation.

13. A system for creating an animated presentation, comprising:
a blank canvas arrangement, said blank canvas arrangement being configured to allow a user to edit a frame to be included in the animated presentation;
an editing tools arrangement, said editing tools arrangement comprising a plurality of tools for the user to edit the animated presentation; and
an object toolbar arrangement, said object toolbar arrangement comprising a plurality of objects for the user to include in the animated presentation.

14. The system according to claim 13, wherein the editing tools arrangement comprises: a color palette arrangement; an eraser tool, wherein the eraser tool is used to fix mistakes made while editing the frame; a paint brush tool, wherein the paint brush tool is used to paint strokes on the frame; a spray-can tool, wherein the spray-can tool is used for spray painting the frame; a paint-can tool, wherein the paint-can tool is used to fill a large area of the frame with paint.

15. The system according to claim 14, wherein the editing tools arrangement further comprises: an editing tool tip selector arrangement; and an editing tool size selector arrangement.

16. The system according to claim 13, wherein the object toolbar arrangement comprises at least one pre-drawn object that the user can include in the animated presentation.

17. The system according to claim 16, wherein the at least one pre-drawn object is a manipulable puppet, wherein the manipulable puppet comprises at least one joint allowing the user to manipulate at least one limb as part of the animated presentation.

18. The system according to claim 13, further comprising a publishing arrangement, said publishing arrangement being configured to allow the user to save, upload, and publish the animated presentation to an online community where other users can view the animated presentation.

19. The system according to claim 13, further comprising a timeline arrangement, said timeline arrangement being configured to allow the user to move between frames of the animated presentation in order to edit each frame individually.

20. The system according to claim 19, wherein the timeline arrangement is further configured to allow the user to alternate between a foreground layer and a background layer of the frame to create a multi-layered animated presentation.

21. The system according to claim 20, wherein the timeline arrangement is further configured to allow the user to hide the background layer or the foreground layer in order to edit one layer without the other layer being visible.

22. The system according to claim 13, further comprising a ghost frame arrangement, said ghost frame arrangement allowing the user to smooth a transition between a current frame and a previous frame or a next frame.

23. The system according to claim 22, wherein the ghost frame arrangement allows the user to show the previous frame or the next frame superimposed on the current frame in ghost form.

24. A computer readable medium storing instructions for an animated presentation creation application, wherein the instructions are arranged to cause one or more processors, upon execution, to perform the steps of: receiving a first input representing a pre-drawn object to be placed in a first frame of the animated presentation; receiving a second input indicating the replication of the first frame into a second frame; receiving a third input indicating at least a rotational operation to be performed on a portion of the pre-drawn object, and in response thereto, rotating a portion of the pre-drawn object around an indicated axis of rotation; receiving additional inputs for additional frames; and serially displaying all frames in a predetermined order to create the animated presentation.

25. The computer readable medium storing instructions for an animated presentation creation application of claim 24, wherein the instructions are arranged to cause one or more processors, upon execution, to perform the additional step of receiving input indicating a translational operation to be performed on pre-drawn object.

26. A computer readable medium storing instructions for an animated presentation creation application according to claim 24, said instructions further configured to share an animated presentation with a online community of application users and viewers in a browser or to download the animated presentation to view and share on computers.
